(19) United States
(12) Patent Application Publication
(10) Pub. No.: US 2010/0100531 A1
(43) Pub. Date: Apr. 22, 2010

(54) ELECTRONIC DEVICE AND METHOD FOR MANAGING MEDIAS

(75) Inventors: Xiao-Guang Li, Shenzhen City, (CN); Xiao-Fang Chen, Shenzhen City (CN); Zai-An Pan, Shenzhen City (CN); Ming-Feng Tsai, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/427,703

(22) Filed: Apr. 21, 2009

(30) Foreign Application Priority Data
Oct. 20, 2008 (CN) 200810305013.4

(51) Int. Cl. G06F 17/30

(52) U.S. Cl. 707/662; 707/E17.005; 707/E17.014; 707/E17.044

(57) ABSTRACT

A method for managing medias of an electronic device is provided. The method includes: detecting whether a communication connection between the electronic device and the computer is established; searching a first type of medias of electronic device if yes; moving the first type of medias from the electronic device to the computer; searching a second type of medias of the computer; and downloading the second type of medias from the computer to the electronic device. An electronic device executing the method is also provided.

### RELATED APPLICATIONS

This application is related to a co-pending U.S. patent application filed concurrently herewith whose Attorney Docket No is US 24893 and entitled “COMPUTER EXECUTABLE PROGRAM FOR MANAGING MEDIAS,” which is incorporated herein in by reference.

### BACKGROUND

1. Technical Field

The disclosure relates to electronic devices and, particularly, to an electronic device capable of managing medias and a method thereof.

2. Description of Related Art

Nowadays, many electronic devices, e.g., mobile phones, digital photo frames, electronic readers (e-reader), are capable of storing and displaying a plurality of digital medias (e.g., digital images, digital texts, etc). Generally, those digital medias have a limited storage capacity. A user has to spend time to manually delete some medias when the user wants to add new medias to an electronic device, which has no free space left.

Additionally, people often like to download digital medias from a computer or other type of media storage such as a server to an electronic device, which is also time consuming.

Therefore, it is necessary to provide a computer executable program to overcome the above-identified deficiencies.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of an electronic device in accordance with an exemplary embodiment.

FIG. 2 is a schematic diagram illustrating a method for managing medias applied in the electronic device of FIG. 1, in accordance with an exemplary embodiment.

### DETAILED DESCRIPTION

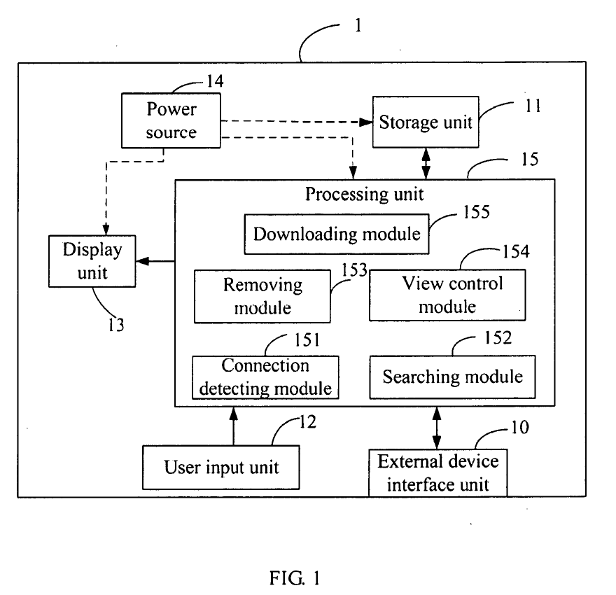

Referring to FIG. 1, an electronic device 1 includes an external device interface unit 10 such as an input port or wireless transceiver, a storage unit 11, a user input unit 12, a display unit 13, a power source 14, and a processing unit 15.

The external device interface unit 10 is configured to connect to an external electronic device (not shown). The external device can be a storage card (e.g., a secure digital (SD) card, a compact flash (CF) card) or another electronic device (e.g., a digital camera, a mobile phone, or a computer).

The user input unit 12 is configured to generate instructions in response to users' operations. The user input unit 12 can be an input key/button, a knob, or the like. The power source 14 is configured to provide power to elements of the electronic device 1, such as to the processing unit 15 and the display unit 13 of the electronic device 1.

The storage unit 11 is configured to store medias such as digital images, digital text, audio media, or the like. The display unit 13 is configured to display those digital medias. In the embodiments digital images (hereinafter images) are used as an example to illustrate the present device and method.

The processing unit 15 includes a connection detecting module 151, a searching module 152, a removing module 153, a view control module 154, and a downloading module 155.

The connection detecting module 151 is configured for detecting whether a communication connection between the electronic device 1 and the computer is established. In the exemplary embodiment, the external device interface unit 10 is a universal serial bus (USB) port (not shown). When the USB port is connected to a counterpart port of the computer, a voltage at the USB port of the electronic device 1 is changed, the connection detecting module 151 determines that the communication connection between the electronic device 1 and the computer is established when it detects the voltage change at the USB port, and the connection detecting module 151 accordingly outputs a trigger signal. In another exemplary embodiment, the external device interface unit 10 can be a serial port, an IEEE 1394 port, or the like. In still another exemplary embodiment, the external device interface unit 10 can be a wireless communication unit, and the electronic device 1 and the computer are connected to each other in a wireless mode.

The view control module 154 is configured for accessing medias in response to a user's request to view the medias. A record of a media is kept by the view control module 154 when the media is accessed and viewed. The record includes the date and time the media was accessed. The view control module 154 can a media viewer. In the embodiment, the view control module 154 is an image viewer configured for viewing images, a record of an image is kept by the view control module 154 when the image is viewed in full size.

The searching module 152 is configured to search a first type of images in the portable electronic device 20 after the communication between the computer and the electronic device 1 is established. In the exemplary embodiment, the first type of medias are those which have not been viewed in full size exceeding a first predetermined time period (e.g., a month). The searching module 152 searches the first type of images according to the records kept by the view control module 154, for example, if there is no record of an image within the first predetermined time period, the searching module 152 determines the image is the first type of images. The removing module 153 is configured to move the first type of images to the computer connected to the electronic device 1. The moving of the first type of images is copying the images to the computer and deleting the images from the electronic device 1.

The searching module 152 is also configured to search a second type of images in the computer connected to the electronic device 1. In the exemplary embodiment, the second type of images are those which have been viewed in full size within a second predetermined time period (e.g., fifteen days). The searching module 152 searches for the second type of images according to search criteria preset by the user or software maker. In the exemplary embodiment, the search criteria preset by the user is to search for the images that have been recently viewed in full size, that is within a second predetermined time period, for example, to search through all images in the computer for the images that have been accessed and viewed in the past fifteen days. In one embodiment, the functions of the searching module 152 may be performed by a standard search module of the computers operating system. The downloading module 155 is configured to download the second type of images from the computer to the electronic device 1.

The first predetermined time period and the second predetermined time period can be set by the user, or provided in the electronic device 1 as system defaults.

In another embodiment, the first type of images can be those which have been viewed less than a first predetermined times within the first predetermined time period, and the second type of images can be those which have been viewed more than a second predetermined times within the second predetermined time period.

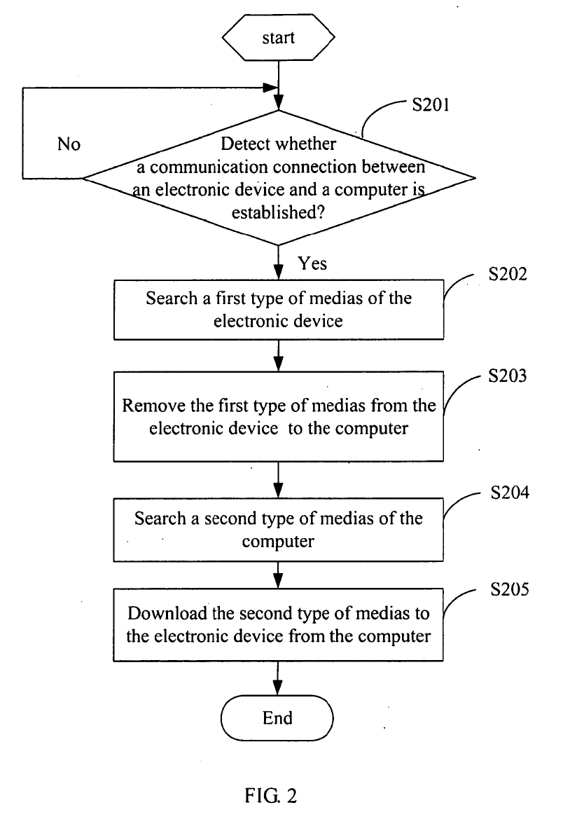

FIG. 2 is a flowchart illustrating a method for managing medias applied in the electronic device 1 in an exemplary embodiment. In step S201, the connection detecting module 151 detects whether a communication connection is established between the electronic device 1 and a computer (not shown).

If the communication connection is established, in step S202, the searching module 152 searches a first type of medias in the electronic device 1. For example, the searching module 152 searches the medias which have not been viewed exceeding a predetermined time period.

In step S203, the removing module 153 moves the first type of medias from the electronic device 1 to the computer.

In step S204, the searching module 152 searches a second type of medias in the computer, for example, the searching module 152 searches the medias have been viewed within a second predetermined time period.

In step S205, the downloading module 155 downloads the second type of medias from the computer to the electronic device 1.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An electronic device, comprising:
a storage unit configured for storing medias; and
a processing unit;
wherein, the processing unit further comprises:
a connection detecting module configured for detecting whether a communication connection between the electronic device and a computer is established, and producing a trigger signal on condition of the communication connection having been established;
a searching module configured for searching a first type of medias stored in the storage unit when receiving the trigger signal; and
a removing module configured for moving the first type of medias from the electronic device to the computer.

2. The electronic device of claim 1, wherein the searching module is further configured for searching a second type of medias in the computer when the communication connection between the electronic device and the computer is established; and the processing unit further comprises a downloading module configured for downloading the second type of medias from the computer to the electronic device.

3. The electronic device of claim 1, wherein the processing unit further comprises a view control module configured for accessing the medias stored in the storage unit, and keeping a record of a media on condition that the media is accessed and viewed, the record comprises a date and time the media accessed.

4. The electronic device of claim 3, wherein, the searching module configured for searching the first type of medias according to the records of the view control module.

5. The electronic device of claim 1, wherein the first type of medias are those which have not been viewed exceeding a first predetermined time period or have been viewed less than a predetermined times within the first predetermined time period.

6. The electronic device of claim 2, wherein the second type of medias are those which have been viewed within a second predetermined time period.

7. The electronic device of claim 1, wherein the electronic device is selected from the group consisting of an e-reader, a mobile phone, and a digital photo frame.

8. A method adapted for an electronic device for managing medias stored therein, the method comprising:
detecting whether a communication connection between the electronic device and a computer is established;
searching a first type of medias in the electronic device if the communication connection is established; and
moving the first type of medias from the electronic device to the computer.

9. The method of claim 8, further comprising:
searching a second type of medias in the computer; and
downloading the second type of medias from the computer to the electronic device.

10. The method of claim 8, wherein the step of searching a first type of media of the electronic device if a communication connection between the electronic device and the computer is established comprises:
searching a record of a view control module, the record recording a date and time the media accessed; and
determining the media is the first type of medias if the media have not been viewed exceeding a first predetermined time period or have been viewed less than a predetermined times within the first predetermined time period according to the record.

11. The method of claim 9, wherein the step of searching a second type of medias in the computer comprises:
searching the medias have been viewed within a second predetermined time period.
